(19) United States
(12) Patent Application Publication
(10) Pub. No.: US 2026/0361479 A1
(43) Pub. Date: Nov. 12, 2026

(54) SINGLE DOWNLINK SUBBAND INDICATION FOR SUBBAND FULL DUPLEX

(71) Applicant: QUALCOMM Incorporated, San Diego, CA (US)

(72) Inventors: Muhammad Sayed Khairy ABDELGHAFFAR, San Jose, CA (US); Jae Ho RYU, San Diego, CA (US); Qian ZHANG, Basking Ridge, NJ (US); Prashant SHARMA, San Marcos, CA (US)

(21) Appl. No.: 19/569,196

(22) Filed: Mar. 17, 2026

Related U.S. Application Data
(60) Provisional application No. 63/802,495, filed on May 8, 2025.

(51) Int. Cl. H04L 5/00; H04L 5/14; H04W 74/0833; H04W 76/27

(52) U.S. Cl. CPC H04L 5/0044; H04L 5/1423; H04W 74/0833; H04W 76/27

(57) ABSTRACT

Various aspects of the present disclosure generally relate to wireless communication. In some aspects, a user equipment (UE) may transmit a message indicating a capability associated with reception of downlink communications via only one downlink subband per subband full duplex (SBFD) symbol. The UE may receive a downlink message from a network node and via a downlink bandwidth part (BWP) within an SBFD symbol comprising a plurality of downlink subbands in accordance with the capability. In some aspects, the downlink BWP may be configured such that frequency resources for the downlink BWP are contained within a single downlink subband of the SBFD symbol. Numerous other aspects are described.

### CROSS-REFERENCE TO RELATED APPLICATION

This Patent Application claims priority to U.S. Provisional Patent Application No. 63/802,495, filed on May 8, 2025, entitled “SINGLE DOWNLINK SUBBAND INDICATION FOR SUBBAND FULL DUPLEX,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with a single downlink subband indication for subband full duplex.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices using system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Some wireless communication networks may implement subband full duplex (SBFD) communication techniques, where simultaneous transmission and reception is enabled within a same frequency band by utilizing separate subbands for uplink and downlink operations. For example, a wireless communication network may configure uplink slots dedicated for uplink communications, downlink slots dedicated for downlink communications, and SBFD slots having at least one uplink subband and at least one downlink subband.

### SUMMARY

The systems, methods, and devices of this disclosure each have several innovative aspects, no single one of which is solely responsible for the desirable attributes disclosed herein.

Some aspects described herein relate to an apparatus at a user equipment (UE) for wireless communication. The apparatus may include one or more memories and one or more processors. The one or more processors, individually or collectively, and based at least in part on information stored in the one or more memories, may be configured to transmit a message indicating a capability associated with reception of downlink communications via only one downlink subband per subband full duplex (SBFD) symbol; and receive a downlink message from a network node and via a downlink bandwidth part (BWP) within an SBFD symbol comprising a plurality of downlink subbands in accordance with the capability.

Some aspects described herein relate to an apparatus at a network node for wireless communication. The apparatus may include one or more memories and one or more processors. The one or more processors, individually or collectively, and based at least in part on information stored in the one or more memories, may be configured to receive a message indicating a capability of a UE associated with reception of downlink communications via only one downlink subband per SBFD symbol. The processing system may be configured to cause the one or more processors, the one or more processors, individually or collectively and based at least in part on information stored in the one or more memories, being configured to transmit a downlink message to the UE and via a downlink BWP comprising a plurality of downlink subbands in accordance with the message.

Some aspects described herein relate to a method of wireless communication. The method may include transmitting, by a UE, a message indicating a capability associated with reception of downlink communications via only one downlink subband per SBFD symbol. The method may include receiving, by the UE, a downlink message from a network node and via a downlink BWP within an SBFD symbol comprising a plurality of downlink subbands in accordance with the capability.

Some aspects described herein relate to a method of wireless communication. The method may include receiving, by a network node, a message indicating a capability of a UE associated with reception of downlink communications via only one downlink subband per SBFD symbol. The method may include transmitting, by the network node, a downlink message to the UE and via a downlink BWP comprising a plurality of downlink subbands in accordance with the message.

Some aspects described herein relate to a non-transitory computer-readable medium that stores a set of instructions for wireless communication by a UE. The set of instructions, when executed by one or more processors of the UE, may cause the UE to transmit a message indicating a capability associated with reception of downlink communications via only one downlink subband per SBFD symbol. The set of instructions, when executed by one or more processors of the UE, may cause the UE to receive a downlink message from a network node and via a downlink BWP within an SBFD symbol comprising a plurality of downlink subbands in accordance with the capability.

Some aspects described herein relate to a non-transitory computer-readable medium that stores a set of instructions for wireless communication by a network node. The set of instructions, when executed by one or more processors of the network node, may cause the network node to receive a message indicating a capability of a UE associated with reception of downlink communications via only one downlink subband per SBFD symbol. The set of instructions, when executed by one or more processors of the network node, may cause the network node to transmit a downlink message to the UE and via a downlink BWP comprising a plurality of downlink subbands in accordance with the message.

Some aspects described herein relate to an apparatus for wireless communication. The apparatus may include means for transmitting a message indicating a capability associated with reception of downlink communications via only one downlink subband per SBFD symbol. The apparatus may include means for receiving a downlink message from a network node and via a downlink BWP within an SBFD symbol comprising a plurality of downlink subbands in accordance with the capability.

Some aspects described herein relate to an apparatus for wireless communication. The apparatus may include means for receiving a message indicating a capability of a UE associated with reception of downlink communications via only one downlink subband per SBFD symbol. The apparatus may include means for transmitting a downlink message to the UE and via a downlink BWP comprising a plurality of downlink subbands in accordance with the message.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings and appendix. Details of one or more implementations of the subject matter described in this disclosure are set forth in the accompanying drawings, the appendix, and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of subband full duplex (SBFD) activation.

FIG. 3 is a diagram illustrating examples associated with bandwidth part (BWP) scheduling in accordance with a single subband indication for SBFD.

FIG. 4 is a diagram illustrating examples associated with BWP scheduling in accordance with a single subband indication for SBFD.

FIG. 5 is a diagram illustrating an example associated with switching durations in accordance with a single subband indication for SBFD.

FIG. 6 is a diagram illustrating an example associated with common signaling transmission in accordance with a single subband indication for SBFD.

FIG. 7 is a diagram of an example associated with a single subband indication for SBFD.

FIG. 8 is a diagram illustrating an example process performed, for example, at a user equipment (UE) or an apparatus of a UE.

FIG. 9 is a diagram illustrating an example process performed, for example, at a network node or an apparatus of a network node.

FIG. 10 is a diagram of an example apparatus for wireless communication.

FIG. 11 is a diagram of an example apparatus for wireless communication.

### DETAILED DESCRIPTION

Some wireless communication networks may implement subband full duplex (SBFD) communication techniques, where simultaneous transmission and reception is enabled within a same frequency band by utilizing separate subbands for uplink and downlink operations. For example, a wireless communication network may configure uplink symbols dedicated to uplink communications, downlink symbols dedicated to downlink communications, and SBFD symbols having at least one uplink subband and at least one downlink subband for communications between at least one user equipment (UE) and a network node. Accordingly, SBFD communication techniques may increase spectral efficiency relative to non-SBFD techniques by allowing full-duplex communications, where data can be sent and received concurrently, thereby increasing the capacity and throughput of the wireless communication network.

In some cases, UEs in the wireless communication network may have varying capabilities, ranging from high-tier devices with advanced features to low-tier devices designed for cost-sensitive applications. Low-tier UEs, also known as reduced capability UEs, are particularly relevant in scenarios requiring large-scale, low-cost connectivity, such as Internet of Things (IoT) deployments, industrial automation, and smart city applications. These devices may often prioritize simplicity and efficiency over feature-rich functionality to reduce costs and power consumption. Accordingly, the wireless communication network may be configured to maintain compatibility between different UE designs and constraints.

In some cases, a UE (e.g., a low-tier UE) may support reception in only one downlink subband at a given time, even during an SBFD symbol that includes multiple downlink subbands. The limitation of the UE may pose challenges for configuring network nodes of the wireless communication network. For example, a downlink bandwidth part (BWP) may be configured to span multiple downlink subbands of the SBFD symbol, which may create challenges when the UE attempts to monitor the downlink BWP and receive DL signal/channel within the whole downlink BWP (e.g., during a random access procedure). Additionally, or alternatively, the UE may be unable to receive and monitor for common signaling, such as a synchronization signal block (SSB), a channel state information (CSI) reference signal (CSI-RS), or a common search space (CSS) transmission (e.g., CSS0), when the common signaling is transmitted via multiple downlink subbands.

Various aspects relate generally to enhancing a single downlink subband indication for SBFD operations. Some aspects more specifically relate to configuring a UE to transmit a capability indicating support for receiving downlink communications via only one downlink subband per SBFD symbol (or SBFD slot). In some aspects, a downlink BWP for the UE may be configured in accordance with the capability. For example, the downlink BWP may be configured such that frequency resources for the downlink BWP are contained entirely within one of the downlink subbands of the SBFD symbol. Additionally, or alternatively, the downlink BWP may be configured such that the frequency resources are larger than one downlink subband, but usable physical resource blocks (PRBs) configured for the UE may be contained within one downlink subband. Additionally, or alternatively, the usable PRBs may span more than one downlink subband, and the UE may be configured, by the network node, with one or more scheduling restrictions limiting measurements to usable PRBs within one downlink subband. In some aspects, the UE may indicate (e.g., via a capability message) one or more switching durations associated with transitions between wideband (e.g., within a non-SBFD slot or symbol) and narrowband (e.g., within subbands of an SBFD slot or symbol), or for switching between a first downlink subband and a second downlink subband uplink of an SBFD symbol (e.g., when common signaling is scheduled for a different downlink subband). In some aspects, the UE may indicate the capability using an early indication message. For example, the UE may indicate the capability while operating in an idle mode or an inactive mode (e.g., radio resource control (RRC) idle or inactive), which may allow a network node to schedule downlink messages within a single downlink subband of SBFD symbols for an access procedure between the UE and the network node or for transmission of common signaling.

Particular aspects of the subject matter described in this disclosure can be implemented to realize one or more of the following potential advantages. By configuring the UE to transmit the capability to receive signaling via only one downlink subband during SBFD symbols, the network node may configure downlink resources such that the UE is able to successfully receive downlink messages. In some aspects, by configuring the UE to indicate the capability in an idle or inactive mode, the described techniques can be used to configure common signaling for reception by the UE when the UE initiates connection with a network node (e.g., to operate in an active mode or RRC active mode). Additionally, the described techniques may allow for the configuration of BWPs, scheduling restrictions for PRBs, and signaling resources for the UE in accordance with the capabilities of the UE, which may facilitate reception of downlink messages by a low-tier UE. By transmitting switching duration information, the UE may enable the network node to account for the time required for the UE to retune filters and front-end components during transitions, thereby facilitating smoother transitions and reception of downlink messages by the UE.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

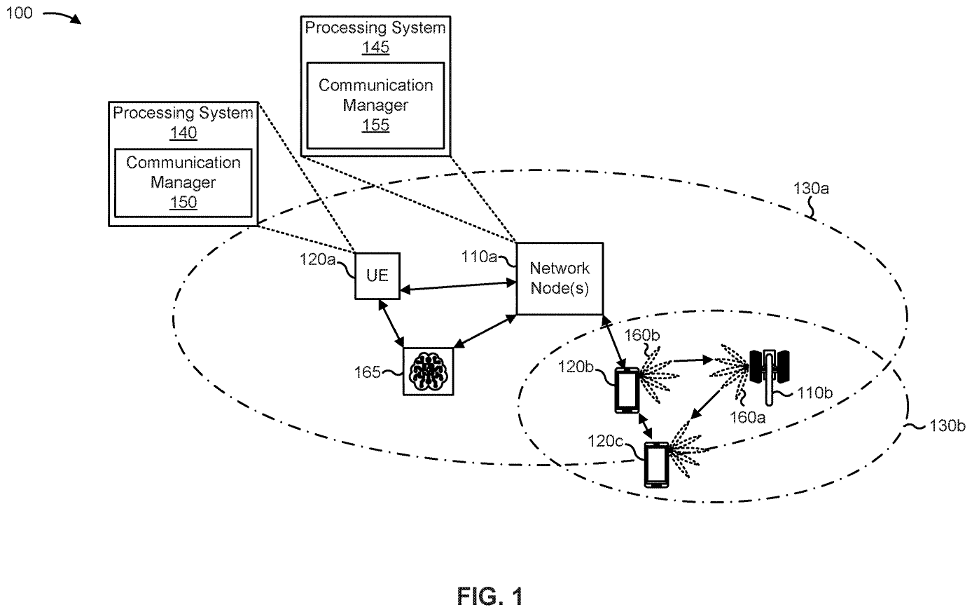

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4(52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, multiple RUs may simultaneously serve a UE 120.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into BWPs. A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a CSI-RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may transmit a message indicating a capability associated with reception of downlink communications via only one downlink subband per SBFD symbol; and receive a downlink message from a network node and via a downlink BWP within an SBFD symbol comprising a plurality of downlink subbands in accordance with the capability. Additionally, or alternatively, the communication manager 150 may perform one or more other operations described herein.

In some aspects, the network node 110 may include a communication manager 155. As described in more detail elsewhere herein, the communication manager 155 may receive a message indicating a capability of a UE associated with reception of downlink communications via only one downlink subband per SBFD symbol; and transmit a downlink message to the UE and via a downlink BWP comprising a plurality of downlink subbands in accordance with the message. Additionally, or alternatively, the communication manager 155 may perform one or more other operations described herein.

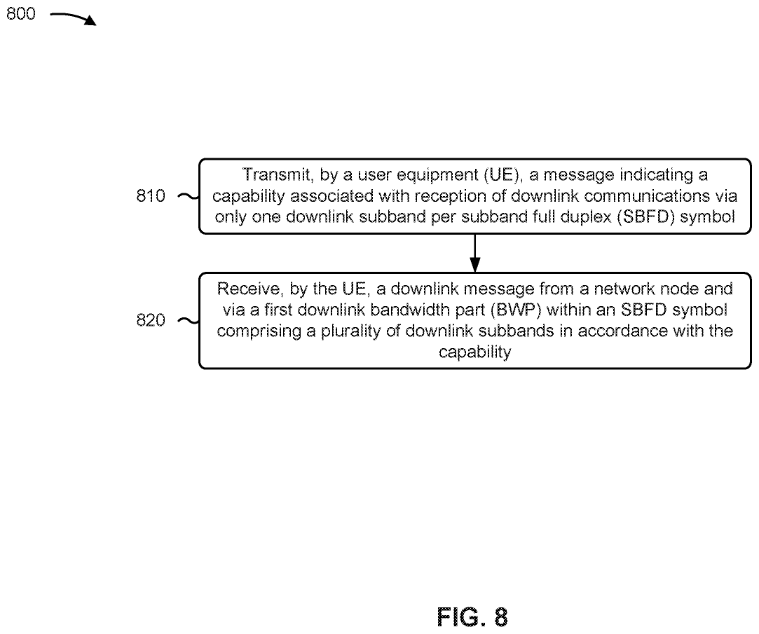

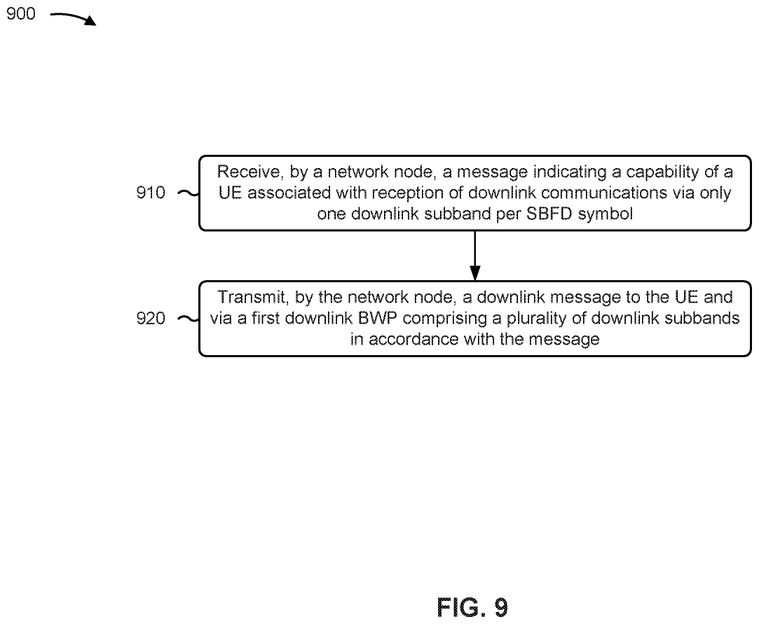

The network node 110, the processing system 145 of the network node 110, the UE 120, the processing system 140 of the UE 120, or any other component(s) of FIG. 1 may implement one or more techniques or perform one or more operations associated with a single subband indication for SBFD, as described in more detail elsewhere herein. For example, the processing system 145 of the network node 110, or the processing system 140 of the UE 120 may perform or direct operations of, for example, process 800 of FIG. 8, process 900 of FIG. 9, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 800 of FIG. 8, process 900 of FIG. 9, or other processes as described herein. In some examples, executing instructions may include running the instructions, converting the instructions, compiling the instructions, or interpreting the instructions, among other examples.

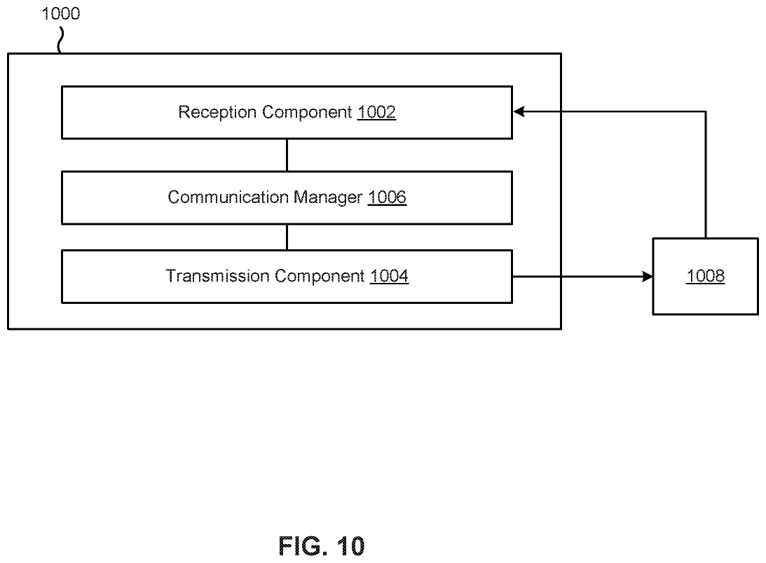

In some aspects, the UE 120 includes means for transmitting a message indicating a capability associated with reception of downlink communications via only one downlink subband per SBFD symbol; or means for receiving a downlink message from a network node and via a downlink BWP within an SBFD symbol comprising a plurality of downlink subbands in accordance with the capability. The means for the UE 120 to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

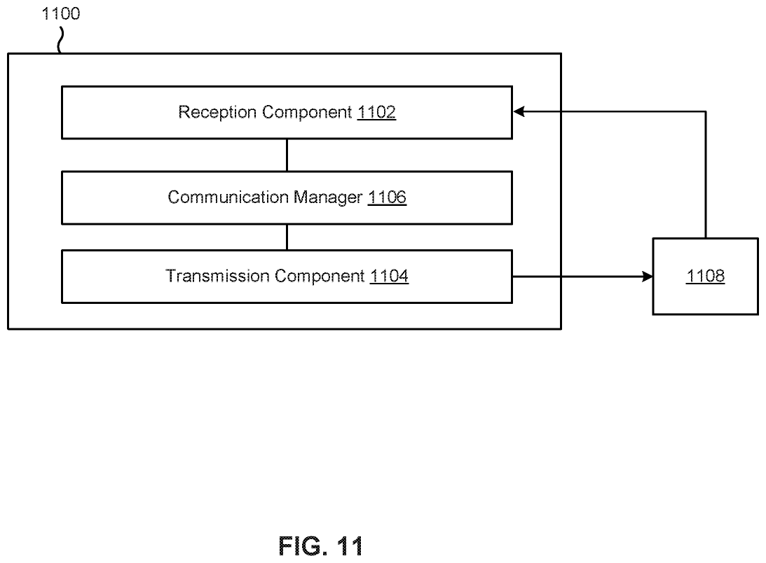

In some aspects, the network node 110 includes means for receiving a message indicating a capability of a UE 120 associated with reception of downlink communications via only one downlink subband per SBFD symbol; or means for transmitting a downlink message to the UE 120 and via a downlink BWP comprising a plurality of downlink subbands in accordance with the message. The means for the network node 110 to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

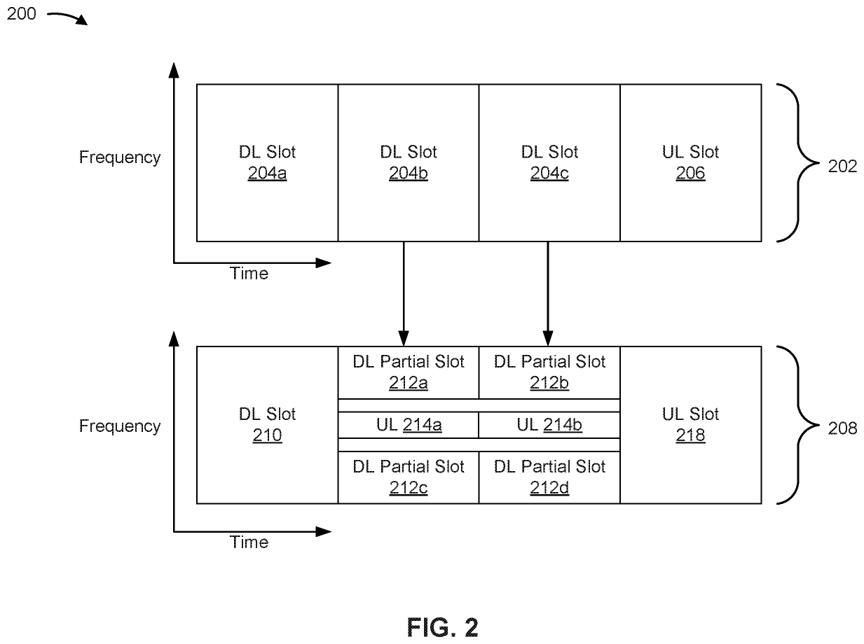

FIG. 2 is a diagram illustrating an example 200 of SBFD activation. As shown in FIG. 2, example 200 includes a first configuration 202. In some aspects, the first configuration 202 may indicate a first slot format pattern (sometimes called a time division duplex (TDD) pattern) associated with a half-duplex mode or a full-duplex mode. The first slot format pattern may include a quantity of downlink slots (e.g., three downlink slots 204a, 204b, and 204c, as shown), a quantity of flexible slots (not shown), or a quantity of uplink slots (e.g., one uplink slot 206, as shown). The first slot format pattern may repeat over time. In some aspects, a network node 110 may indicate the first slot format pattern to a UE 120 using one or more slot format indicators. A slot format indicator, for a slot, may indicate whether that slot is an uplink slot, a downlink slot, or a flexible slot, among other examples.

A network node 110 may instruct (e.g., using an indication, such as an RRC message, a MAC-CE, or DCI) a UE 120 to switch from the first configuration 202 to a second configuration 208. As an alternative, the UE 120 may indicate to the network node 110 that the UE 120 is switching from the first configuration 202 to the second configuration 208. The second configuration 208 may indicate a second slot format pattern that repeats over time, similar to the first slot format pattern. In any of the aspects described above, the UE 120 may switch from the first configuration 202 to the second configuration 208 during a time period (e.g., a quantity of symbols or an amount of time, which may be in milliseconds)) based at least in part on an indication received from the network node 110 (e.g., before switching back to the first configuration 202). During that time period, the UE 120 may communicate using the second slot format pattern, and then may revert to using the first slot format pattern after the end of the time period. The time period may be indicated by the network node 110 (e.g., in the instruction to switch from the first configuration 202 to the second configuration 208, as described above) or based at least in part on a programmed or otherwise preconfigured rule. For example, the rule may be based at least in part on a table (e.g., defined in 3GPP specifications or another wireless communication standard) that associates different SCSs or numerologies (e.g., represented by μand associated with corresponding SCSs) with corresponding time periods for switching configurations.

In example 200, the second slot format pattern includes two SBFD slots in place of what were downlink slots in the first slot format pattern. In example 200, each SBFD slot includes a partial slot (e.g., a portion or sub-band of a frequency allocated for use by the network node 110 and the UE 120) for downlink (e.g., partial slots 212a, 212b, 212c, and 212d, as shown) and a partial slot for uplink (e.g., partial slots 214a and 214b, as shown). Accordingly, the UE 120 may operate using the second slot format pattern to transmit an uplink communication in an earlier slot (e.g., the second slot in sequence, shown as partial UL slot 214a) as compared to using the first slot format pattern (e.g., the fourth slot in sequence, shown as UL slot 206). Other examples may include additional or alternative changes. For example, the second configuration 208 may indicate an SBFD slot in place of what was an uplink slot in the first configuration 202 (e.g., UL slot 206). In another example, the second configuration 208 may indicate a downlink slot or an uplink slot in place of what was an SBFD slot in the first configuration 202 (not shown in FIG. 2). In yet another example, the second configuration 208 may indicate a downlink slot or an uplink slot in place of what was an uplink slot or a downlink slot, respectively, in the first configuration 202. An “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 2). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using a full duplex (FD) mode in one or more slots based at least in part on the one or more slots having the SBFD format. A slot may support the SBFD mode if an UL BWP and a DL BWP are permitted to be or are simultaneously active in the slot in an SBFD fashion (e.g., with guard band separation).

By switching from the first configuration 202 to the second configuration 208, the network node 110 and the UE 120 may experience increased quality or reliability of communications. For example, the network node 110 and the UE 120 may experience increased throughput (e.g., using a full-duplex mode), reduced latency (e.g., the UE 120 may be able to transmit an uplink or a downlink communication sooner using the second configuration 208 rather than the first configuration 202), and increased network resource utilization (e.g., by using both the DL BWP and the UL BWP simultaneously instead of only the DL BWP or the UL BWP).

In some aspects, a UE 120 may be configured to transmit a capability indicating support for receiving downlink communications via only one downlink partial slot 212 (e.g., subband) at a time (e.g., per each SBFD symbol or SBFD slot). In some aspects, a downlink BWP for the UE 120 may be configured (e.g., by a network node 110) in accordance with the capability. For example, the downlink BWP may be configured such that frequency resources for the downlink BWP are contained entirely within one of the downlink partial slots 212. Additionally, or alternatively, the downlink BWP may be configured such that the frequency resources are larger than one downlink partial slot 212, but usable physical resource blocks (PRBs) configured for the UE 120 may be contained within one downlink partial slot 212. Additionally, or alternatively, the usable PRBs may span more than one downlink partial slot 212, and the UE 120 may be configured, by the network node 110, with one or more scheduling restrictions limiting measurements to usable PRBs within one downlink partial slot 212. In some aspects, the UE 120 may indicate (e.g., via a capability message) one or more switching durations associated with transitions between wideband (e.g., within a DL slot 210 or an UL slot 218) and narrowband (e.g., within a downlink partial slot 212 or an uplink partial slot 214), or for switching between the downlink partial slots 212 having different frequency resources. For example, the UE 120 may be configured to switch from monitoring the downlink partial slot 212c to monitoring the downlink partial slot 212b when common signaling is scheduled for the downlink partial slot 212b. In some aspects, the UE 120 may indicate the capability using an early indication message. For example, the UE 120 may indicate the capability while operating in an idle mode or an inactive mode (e.g., an RRC idle or inactive mode), which may allow a network node 110 to schedule downlink messages within a single downlink partial slot 212 for an access procedure between the UE 120 and the network node 110 or for transmission of common signaling by the network node 110.

As indicated above, FIG. 2 is provided as an example. Other examples may differ from what is described with respect to FIG. 2.

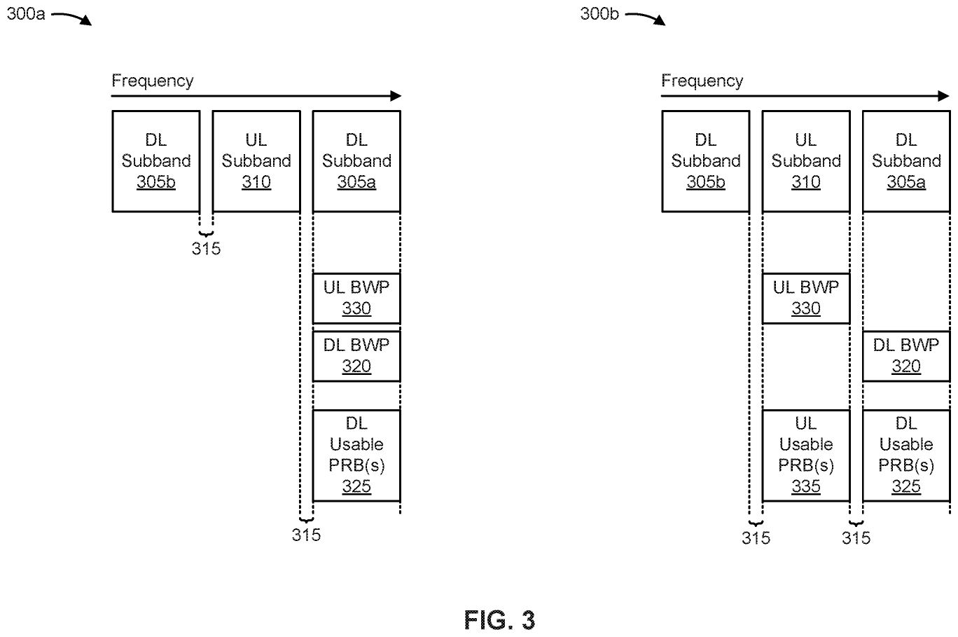

FIG. 3 is a diagram illustrating an example 300a and an example 300b associated with BWP scheduling in accordance with a single subband indication for SBFD. The examples 300a and 300b illustrate scheduling that may be used for communications between a network node 110 and a UE 120. In some aspects, the network node 110 and UE 120 may be included in a wireless communication network, such as wireless communication network 100. The network node 110 and the UE 120 may communicate via a wireless access link, which may include an uplink and a downlink.

As shown in FIG. 3, an SBFD symbol (or slot) may include a downlink subband 305a and a downlink subband 305b configured for downlink communications (e.g., from the network node 110 to one or more UEs 120). Additionally, the SBFD symbol may include an uplink subband 310 configured for uplink communications (e.g., from one or more UEs 120 to the network node 110). In some examples, the downlink subband 305a and the downlink subband 305b are separated from the uplink subband 310 by a respective guard band 315, which may be configured to reduce interference between downlink and uplink communications.

In some aspects, the UE 120 may be configured to transmit, to the network node 110, one or more messages indicating a capability (or a feature or feature set) associated with support for reception via subbands of an SBFD symbol. For example, the UE 120 may transmit a capability that indicates support for receiving downlink communications via only one downlink subband 305 per SBFD symbol. In some aspects, the network node 110 may perform scheduling and resource allocation in accordance with the capability indicated by the UE 120. In some examples, the one or more messages may be transmitted as part of a capability negotiation procedure with the network node 110. For example, the network node 110 may transmit a message acknowledging the capability of the UE 120, or the network node 110 may indicate one or more settings selected in accordance with the capability.

In some aspects, the UE 120 may be configured to transmit the one or more messages indicating the capability while operating in an RRC idle or inactive mode. For example, the UE 120 may transmit a preamble message (e.g., a Msg1 or a MsgA) in a random access occasion (RO) that is configured for indicating the capability. In some aspects, the network node 110 may configure one or more preambles for an RO associated with different capabilities (e.g., a preamble partitioning), such that the UE 120 may select a preamble for transmission of a preamble message that indicates that the UE 120 supports the capability associated with downlink reception via only one downlink subband. For example, one or more preambles may be configured for indicating that a UE 120 supports downlink reception via only one downlink subband, and one or more preambles may be configured for indicating that a UE 120 supports downlink reception via multiple downlink subbands.

Additionally, or alternatively, the network node 110 may configure multiple sets of one or more ROs, where each set of one or more ROs may correspond to a different capability (e.g., associated with a quantity of downlink subbands supported for reception during a symbol). For example, the UE 120 may transmit the preamble message via an RO in a first set of one or more ROs that corresponds to indicating support for reception via only a single downlink subband to indicate the capability to the network node 110. By configuring the UE 120 to indicate the capability via a preamble message, which may be referred to as an “early indication,” the network node 110 may be configured to schedule subsequent downlink messages during an access procedure, such as a Msg2, a MsgB, or a Msg4, common signaling such as a synchronization signal block (SIB) (e.g., SIB1), paging, a small data transmission (SDT), or other communications within a single downlink subband in accordance with the capability of the UE 120.

In some aspects, the UE 120 does not indicate the capability via the preamble message, and the network node 110 may be configured to transmit initial downlink communications (e.g., random access messages) such that the UE 120 is able to receive the downlink communications, paging, or common signaling within any single downlink subband 305. Accordingly, the UE 120 may receive initial communications via a single downlink subband, and the UE 120 may indicate the capability after initiating communications with the network node 110 (e.g., when operating in an RRC connected mode).

In some aspects, the network node 110 may schedule a downlink BWP 320 for the UE 120 in accordance with the reported capability. For example, the network node 110 may configure the downlink BWP 320 such that frequency resources of the downlink BWP 320 are contained entirely within one downlink subband, such as downlink subband 305a. Accordingly, one or more downlink usable PRBs 325 (e.g., PRBs usable by the UE 120 for reception of downlink communications) may be located entirely within a single downlink subband 305, such as the downlink subband 305a, and the UE 120 may receive downlink signaling via the one or more downlink usable PRBs 325.

In some aspects, as shown in the example 300a, the center frequencies for the downlink BWP 320 and for an uplink BWP 330 may be aligned. For example, the downlink BWP 320 and the UL BWP 330 may both be contained within the downlink subband 305 a. Alternatively, as shown in the example 300b, the center frequencies for the downlink BWP 320 and the uplink BWP 330 may be unaligned. For example, the frequency resources for the downlink BWP 320 may be aligned with the downlink subband 305a, and frequency resources for the uplink BWP 330 may be aligned with the uplink subband 310. Accordingly, one or more uplink usable PRBs 335 may be configured for the UE 120, and the one or more uplink usable PRBs 335 may be located within the uplink subband 310 of the SBFD symbol.

As indicated above, FIG. 3 is provided as an example. Other examples may differ from what is described with respect to FIG. 3. For example, although FIG. 3 is described in terms of downlink operations, similar techniques may be applied for uplink communications, such as when multiple uplink subbands 310 are configured for an SBFD symbol.

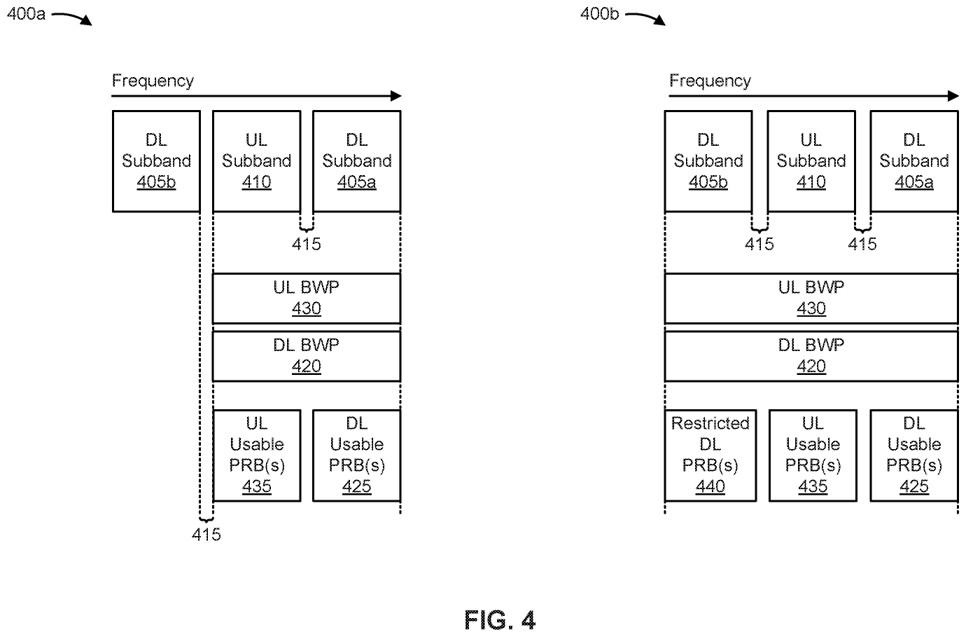

FIG. 4 is a diagram illustrating an example 400a and an example 400b associated with BWP scheduling in accordance with a single subband indication for SBFD. The examples 400a and 400b illustrate scheduling that may be used for communications between a network node 110 and a UE 120. In some aspects, the network node 110 and UE 120 may be included in a wireless communication network, such as wireless communication network 100. The network node 110 and the UE 120 may communicate via a wireless access link, which may include an uplink and a downlink.

As shown in FIG. 4, an SBFD symbol (or slot) may include a downlink subband 405a and a downlink subband 405b configured for downlink communications (e.g., from the network node 110 to one or more UEs 120). Additionally, the SBFD symbol may include an uplink subband 410 configured for uplink communications (e.g., from one or more UEs 120 to the network node 110). In some examples, the downlink subband 405a and the downlink subband 405b are separated from the uplink subband 410 by a respective guard band 415, which may be configured to reduce interference between downlink and uplink communications.

In some aspects, the UE 120 may be configured to transmit, to the network node 110, one or more messages indicating a capability associated with support for reception via a single downlink subband 405 of an SBFD symbol, as described herein. The network node 110 may configure communication parameters in accordance with the capability.

In some aspects, the network node 110 may schedule a downlink BWP 420 for the UE 120 such that the frequency resources of the downlink BWP 420 are larger than a single downlink subband. For example, as shown by the example 400a, the downlink BWP 420 may span the uplink subband 410 and one downlink subband, such as the downlink subband 405a. Accordingly, the downlink BWP 420 may be larger than the downlink BWP 320 described with reference to FIG. 3, which may allow the network node 110 to schedule communications for the UE 120 in a wider frequency range in non-SBFD symbols. In some aspects, one or more usable downlink PRBs 425 may be configured within the downlink subband 405a, which may facilitate reception of downlink communications by the UE 120. Similarly, an uplink BWP 430 may be configured by the network node 110 such that the uplink BWP 430 spans the uplink subband 410 and the downlink subband 405a. In some aspects, one or more uplink usable PRBs 435 may be configured within the uplink subband 410, which may allow transmission of uplink communications by the UE 120.

Alternatively, as shown by the example 400b, the downlink BWP 420 may span both the downlink subband 405a and the downlink subband 405b, and the uplink subband 410, which may facilitate wideband downlink scheduling (e.g., spanning a full frequency band) by the network node 110 in non-SBFD symbols. Similarly, the uplink BWP 430 may span both the downlink subband 405a and the downlink subband 405b and the uplink subband 410. In some aspects, to limit scheduling of downlink messages to only one downlink subband 405, the network node 110 may configure one or more scheduling restrictions to only the one or more downlink usable PRBs 425. For example, one or more downlink PRBs 440 may be restricted and not used for communication downlink messages to the UE 120. Additionally, or alternatively, the UE 120 may be configured (e.g., by the network node 110) to perform measurements only within the downlink subband 405a during SBFD symbols.

In some aspects, the one or more downlink usable PRBs 425 may be configured on the downlink subband 405 on which network node 110 is configured to perform transmission of common signaling, such as SSB transmissions, SIB transmissions (e.g., SIB1), or PDCCH transmissions in CSS occasions (e.g., via CSS0). For example, the network node 110 may transmit the common signaling via the downlink subband 405a, and the one or more downlink usable PRBs may be configured for the downlink subband 405a to enable the UE 120 to receive the common signaling. Additionally, or alternatively, the one or more downlink usable PRBs 425 may be configured on the lower downlink subband 405 (e.g., in the frequency domain) or the first downlink subband (e.g., based on a subband index). By configuring the downlink BWP 420 and the associated PRBs in accordance with the UE's capability, the network node 110 may improve resource utilization while maintaining compatibility with operation constraints of the UE 120.

As indicated above, FIG. 4 is provided as an example. Other examples may differ from what is described with respect to FIG. 4. For example, although FIG. 4 is described in terms of downlink operations, similar techniques may be applied for uplink communications, such as when multiple uplink subbands 410 are configured for an SBFD symbol.

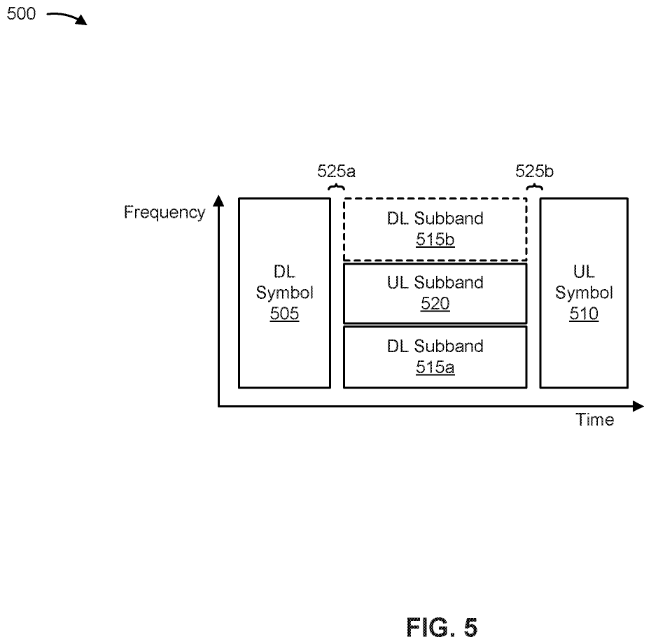

FIG. 5 is a diagram illustrating an example 500 associated with switching durations in accordance with a single subband indication for SBFD. The example 500 illustrates scheduling that may be used for communications between a network node 110 and a UE 120. In some aspects, the network node 110 and UE 120 may be included in a wireless communication network, such as wireless communication network 100. The network node 110 and the UE 120 may communicate via a wireless access link, which may include an uplink and a downlink.

As shown in FIG. 5, a downlink symbol 505 (or downlink slot) and an uplink symbol 510 (or uplink slot), which may be examples of non-SBFD symbols, may be scheduled for communications between the UE 120 and the network node 110. Additionally, an SBFD symbol (or slot) may be configured for communications between the UE 120 and the network node 110, and the SBFD symbol may include a downlink subband 515a, a downlink subband 515b, and an uplink subband 520.

In some cases, the UE 120 may be associated with a switching duration 525 (e.g., a switching timeline or duration) to transition from wideband reception in non-SBFD symbols to narrowband reception in SBFD symbols. For example, when the UE 120 supports reception of downlink communications via only a single downlink subband 515 of the SBFD symbol, the UE 120 may perform retuning of filters or front end radio components during the duration.

Accordingly, in some aspects, a switching duration 525 may be configured to allow the UE 120 to switch between operating within a wideband (e.g., the DL symbol 505) to communications via a narrowband (e.g., a subband of the SBFD symbol). For example, the UE 120 may be configured to only monitor for downlink communications via the downlink subband 515a and not the downlink subband 515b. Accordingly, a switching duration 525a may be configured between the downlink symbol 505 and the SBFD symbol, and the UE 120 may adjust reception parameters or components when transitioning from monitoring for downlink communications via the downlink symbol 505 to monitoring for downlink communications via the downlink subband 515a during the switching duration 525a. Additionally, or alternatively, a switching duration 525b may be configured between the SBFD symbol and the uplink symbol 510, and the UE 120 may adjust reception parameters or hardware components when transitioning from transmitting uplink communications via the uplink subband 520 to transmitting uplink communications via the uplink symbol 510 during the switching duration 525b.

In some aspects, at least one of the switching duration 525a or the switching duration 525b may be configured in accordance with an indication transmitted from the UE 120 to the network node 110. For example, the UE 120 may report a length of the switching duration 525a in terms of a quantity of symbols, a quantity of slots (e.g., for one or more numerologies, which may have different quantities of symbols or slots per subframe due to different SCSs), or an explicit time duration (e.g., in milliseconds or microseconds). The UE 120 may report a same length or different lengths for switching durations 525 for switching from a non-SBFD symbol to an SBFD symbol for downlink reception, switching from a non-SBFD symbol to an SBFD symbol for uplink transmission, switching from an SBFD symbol to a non-SBFD symbol for downlink reception, or switching from an SBFD symbol to a non-SBFD symbol for uplink transmission.

Additionally, or alternatively, a set of candidate durations may be defined (e.g., configured by the network node 110 based on UE reporting of switching durations, or defined in a communication standard), and the UE 120 may report that one or more of the set of candidate durations are supported for the UE 120 for at least one of the switching duration 525a or the switching duration 525b (e.g., to allow sufficient time for the UE 120 to retune parameters or components). In some examples, the network node 110 may configure an RRC parameter that may be used to indicate one or more lengths for the switching duration 525a or the switching duration 525b, or a location of the switching duration 525a or the switching duration 525b (e.g. in the SBFD or non-SBFD symbols). Accordingly, the network node 110 may indicate the one or more lengths and locations via RRC signaling to the UE 120. In some aspects, different switching durations 525 may be configured for switching between different symbol types (e.g., including SBFD and non-SBFD symbols), for switching between uplink and downlink (or vice-versa) between SBFD symbols.

In some aspects, one or more locations for switching durations 525 may be configured, which may indicate whether the switching durations 525 are to be located within non-SBFD symbols (e.g., the downlink symbol 505 or the uplink symbol 510), SBFD symbols, or a combination thereof. For example, the one or more locations may be indicated by the UE 120 (e.g., by indicating a symbol) as part of a capability signaling of the UE 120, or the one or more locations may be configured by the network node 110 or specified in a communication standard.

In some aspects, switching durations 525 may be located within non-SBFD symbols for transitions from downlink symbols 505 to SBFD symbols. Additionally, or alternatively, switching durations 525 may be located within SBFD symbols for transitions from SBFD to uplink symbols 510. Additionally, or alternatively, the switching durations 525 may be split and evenly located between non-SBFD and SBFD symbols. Additionally, or alternatively, the switching durations 525 may be split unevenly across SBFD and non-SBFD symbols, such as by using different durations N1 and N2 (e.g., indicated by the UE 120 or configured by the network node 110). By configuring switching durations 525 in accordance with the capability of the UE 120, smoother transitions and improved communication reliability may be supported for communications between the UE 120 and the network node 110.

As indicated above, FIG. 5 is provided as an example. Other examples may differ from what is described with respect to FIG. 5.

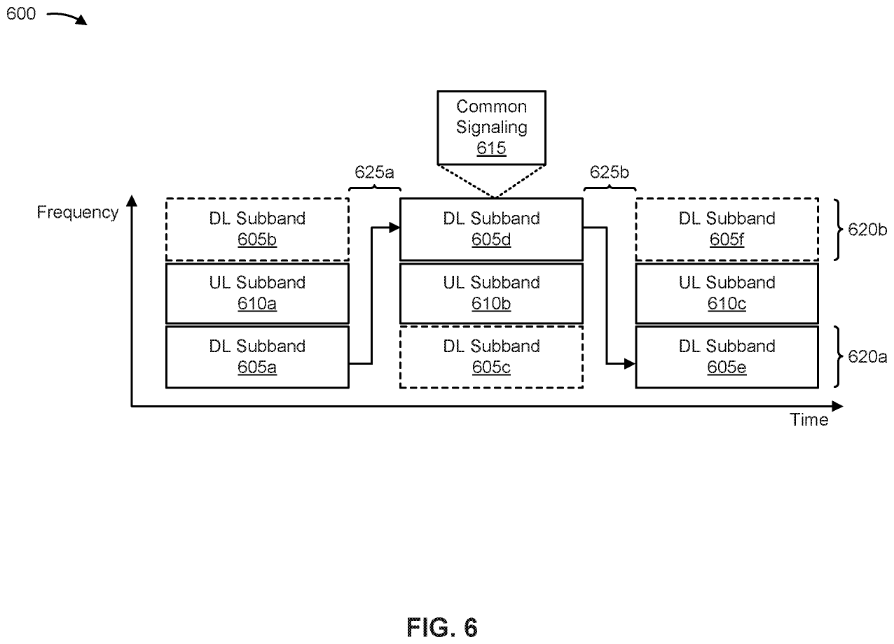

FIG. 6 is a diagram illustrating an example 600 associated with common signaling transmission in accordance with a single subband indication for SBFD. The example 600 illustrates scheduling that may be used for communications between a network node 110 and a UE 120. In some aspects, the network node 110 and UE 120 may be included in a wireless communication network, such as wireless communication network 100. The network node 110 and the UE 120 may communicate via a wireless access link, which may include an uplink and a downlink.

As shown in FIG. 6, a first SBFD symbol (or slot) may include a downlink subband 605a, a downlink subband 605b, and an uplink subband 610a. The second SBFD symbol (or slot) may include a downlink subband 605c, a downlink subband 605d, and an uplink subband 610b. Similarly, a third SBFD symbol (or slot) may include a downlink subband 605e, a downlink subband 605f, and an uplink subband 610c.

In some aspects, the UE 120 may report a capability associated with receiving downlink communications via a single downlink subband, as described herein. For example, when receiving downlink communications during the first SBFD symbol, the UE 120 may be configured to monitor only the downlink subband 605a, and the UE 120 does not monitor the downlink subband 605b.

In some aspects, to transmit downlink common signaling 615 to the UE 120, such as one or more SSBs, one or more SIBs (e.g., SIB1), or one or more CSSs (e.g., CSS0, CSS0A, CSS1, CSS2), the network node 110 may be configured to transmit the common signaling 615 within usable downlink PRBs of the UE 120. For example, the common signaling 615 may be transmitted within downlink PRBs that are contained entirely within frequency resources 620a corresponding to the downlink subband 605a, the downlink subband 605c, and the downlink subband 605e.

Additionally, or alternatively, and as shown in FIG. 6, the network node 110 may be configured to transmit common signaling 615 via different frequency resources, such as frequency resources 620b corresponding to the downlink subband 605b, the downlink subband 605d, and the downlink subband 605f. For example, BWP switching may be performed, and the network node 110 may switch (e.g., configure) a downlink BWP for the UE 120 from the frequency resources 620a to the frequency resources 620b. Accordingly, the UE 120 may receive the common signaling 615 via the downlink subband 605d. In some aspects, the network node 110 may switch (e.g., configure) the downlink BWP for the UE 120 from the frequency resources 620b to the frequency resources 620a after the UE 120 receives the common signaling 615, and the UE 120 may monitor the downlink subband 605e for downlink communications.

Additionally, or alternatively, such as in cases where the downlink BWP is configured to span multiple downlink subbands 605 (e.g., as described with respect to example 400b), the UE 120 may be configured to retune for reception in the frequency resources 620b. For example, the UE 120 may tune reception components or adjust communication parameters (e.g., retune filters or front end reception components) to monitor for downlink communications on usable downlink PRBs of the frequency resources 620b. In some aspects, a switching duration 625a may be configured (e.g., by the network node 110) to allow the UE 120 to retune for reception of the common signaling 615 via the downlink subband 605d. Additionally, or alternatively, a switching duration 625b may be configured (e.g., by the network node 110) to allow the UE 120 to retune back to the frequency resources 620a for reception via the downlink subband 605e.

In some aspects, the switching durations 625 may be defined as described herein, with respect to switching durations 525. For example, the UE 120 may transmit an indication of a length for the switching durations 625 (which may be the same or different for the switching duration 625a and the switching duration 625b), and the indication may be in terms of a quantity of symbols, a quantity of slots per one or more numerologies, or an explicit time duration (e.g., in milliseconds or microseconds). Additionally, or alternatively, the network node 110 may configure the durations 625 (e.g., via one or more RRC parameters), or the lengths of the durations 625 may be defined in a communication standard.

Accordingly, the described techniques allow for the UE 120 to receive the common signaling 615 via a single downlink subband 605 in accordance with the capability of the UE 120.

As indicated above, FIG. 6 is provided as an example. Other examples may differ from what is described with respect to FIG. 6.

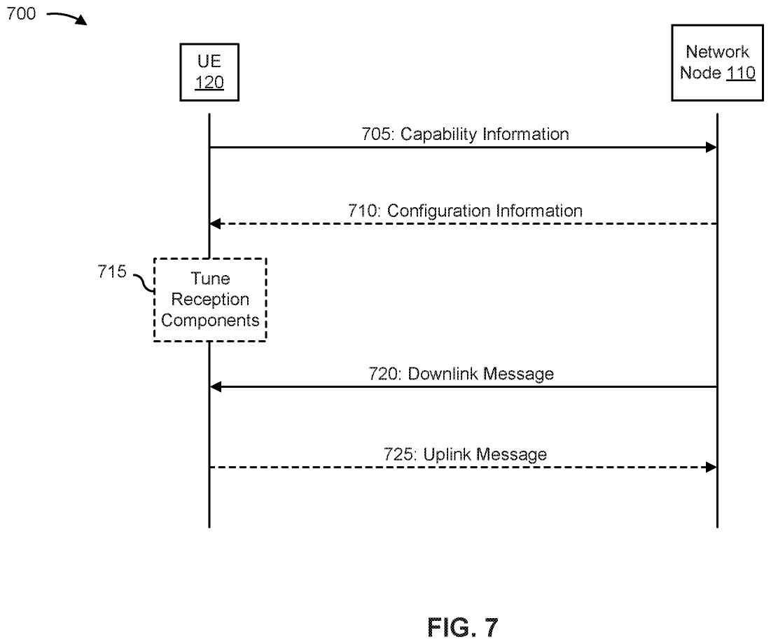

FIG. 7 is a diagram of an example 700 associated with a single subband indication for SBFD. As shown in FIG. 7, a network node 110 (e.g., a base station, a CU, a DU, or an RU) may communicate with a UE 120. In some aspects, the network node 110 and the UE 120 may be part of a wireless network (e.g., the wireless communication network 100).

In some aspects, as shown by reference number 705, the UE 120 may transmit capability information to the network node 110. The capability information may be included in a capability report. The UE 120 may transmit the capability information via an uplink communication, a unicast communication, a broadcast communication, a UE assistance information (UAI) communication, an uplink control information (UCI) communication, a MAC control element (MAC-CE) communication, an RRC communication, a PUCCH, a PUSCH, or a preamble message, among other examples. The capability information may indicate one or more parameters associated with respective capabilities of the UE 120. The one or more parameters may be indicated via respective information elements included in a capability report.

In some aspects, the capability information may indicate support by the UE 120 for receiving downlink communications via only one downlink subband per SBFD symbol. In some examples, the capability information may be transmitted via a preamble message during one or more ROs within SBFD symbols. For example, the network node 110 may configure dedicated ROs for indicating the capability. In some cases, the UE 120 may select one or more ROs corresponding to the capability for receiving downlink communications via only one downlink subband per SBFD symbol. Accordingly, the transmission of the preamble message via the one or more ROs may (e.g., implicitly) indicate to the network node 110 that the UE 120 supports receiving downlink communications via only one downlink subband per SBFD symbol. Additionally, or alternatively, the network node 110 may configure the UE 120 with a set of preambles dedicated for indicating the capability, and the UE 120 may select a preamble in accordance with the capability of the UE 120. Accordingly, the transmission of the preamble message including the selected preamble may (e.g., implicitly) indicate to the network node 110 that the UE 120 supports receiving downlink communications via only one downlink subband per SBFD symbol.

Additionally, or alternatively, the capability information may include information associated with switching durations for transitions between different symbol types, as described with respect to FIGS. 5 and 6. For example, the UE 120 may indicate, via the capability information (or other communications), a length of one or more switching durations in terms of a quantity of symbols, a quantity of slots, or an explicit time duration (e.g., in milliseconds or microseconds), as described herein. In some aspects, the UE 120 may report a same length or different lengths for different switching durations, such as those for switching from a non-SBFD symbol to an SBFD symbol for downlink reception, switching from a non-SBFD symbol to an SBFD symbol for uplink transmission, switching from an SBFD symbol to a non-SBFD symbol for downlink reception, or switching from an SBFD symbol to a non-SBFD symbol for uplink transmission.

As shown by reference number 710, the network node 110 may transmit, and the UE 120 may receive, configuration information. In some aspects, the UE 120 may receive the configuration information via one or more common signaling (e.g., a master information block (MIB) or a SIB, or one or more SSBs, among other examples), RRC signaling, MAC signaling (e.g., one or more MAC-CEs), or physical layer signaling (e.g., DCI), among other examples.

In some aspects, the configuration information may configure a downlink BWP, an uplink BWP, or a combination thereof, in accordance with the capability of the UE 120. The configuration information may involve the allocation of frequency resources within a downlink BWP, ensuring that they are contained entirely within a single downlink subband, as indicated by the UE's capability message. Alternatively, the network node 110 may configure the downlink BWP to span multiple subbands, while usable PRBs for the UE 120 may be limited within the single downlink subband. Additionally, or alternatively, the network node 110 may configure scheduling restrictions to limit downlink communications to a single subband (e.g., by restricting one or more downlink PRBs), such as when the downlink BWP spans multiple downlink subbands. Additionally, or alternatively, the configuration information may configure switching durations (e.g., a length and location for the switching durations) for transitions between SBFD and non-SBFD symbols or vice-versa.

As shown by reference number 715, the UE 120 may tune reception components or parameters for reception via a single downlink subband. For example, the UE 120 may be performing downlink reception via a non-SBFD symbol (e.g., on a wideband), and the UE 120 may adjust its filters, front-end radio components, and other relevant parameters to receive downlink communications via frequency resources of a single downlink subband of an SBFD symbol. In some aspects, the tuning may be performed during a switching duration allocated for transitioning between different symbol types, such as from non-SBFD to SBFD symbols, as described herein.

As shown by reference number 720, the network node 110 may transmit a downlink message to UE 120 in accordance with the capability of the UE 120 associated with receiving communications via a single downlink subband per SBFD symbol. The downlink message may be transmitted within the frequency resources of the configured downlink BWP or usable downlink PRBs, which may be contained entirely within one downlink subband of one or more SBFD symbols. In some examples, such as when the UE 120 transmits the capability information during an idle mode or an inactive mode, the downlink message transmitted by the network node to UE 120 may be or may include common signaling, such as SSBs, SIBs, or CSS transmissions. Accordingly, the UE 120 may receive the downlink message via the single downlink subband in accordance with the capability of the UE 120.

As shown by reference number 725, the UE 120 may transmit an uplink message to the network node 110. For example, the UE 120 may use the configured uplink BWP. In some cases, the UE 120 may transition to uplink transmission during a switching duration, as described herein. In some aspects, the UE 120 may transmit the uplink message via usable uplink PRBs of the uplink BWP, which may be limited to uplink subbands of one or more SBFD symbols, in accordance with the configuration information.

Accordingly, the described techniques may facilitate communications between the UE 120 and the network node 110 in accordance with the capability of the UE 120 to support downlink communications via only a single downlink subband, thereby supporting efficient and reliable communication within the constraints of single subband reception and SBFD operations.

As indicated above, FIG. 7 is provided as an example. Other examples may differ from what is described with regard to FIG. 7. For example, some steps shown may be omitted or performed in a different order than shown, or steps not shown may be added to the example 700.

FIG. 8 is a diagram illustrating an example process 800 performed, for example, at a UE (e.g., UE 120) or an apparatus of a UE. Example process 800 is an example where the apparatus or the UE performs operations associated with a single downlink subband indication for SBFD.

As shown in FIG. 8, in some aspects, process 800 may include transmitting a message indicating a capability associated with reception of downlink communications via only one downlink subband per SBFD symbol (block 810). For example, the UE (e.g., using transmission component 1004 or communication manager 1006, depicted in FIG. 10) may transmit a message indicating a capability associated with reception of downlink communications via only one downlink subband per SBFD symbol, as described above.

As further shown in FIG. 8, in some aspects, process 800 may include receiving a downlink message from a network node and via a downlink BWP within an SBFD symbol comprising a plurality of downlink subbands in accordance with the capability (block 820). For example, the UE (e.g., using reception component 1002 or communication manager 1006, depicted in FIG. 10) may receive a downlink message from a network node and via a downlink BWP within an SBFD symbol comprising a plurality of downlink subbands in accordance with the capability, as described above.

Process 800 may include additional aspects, such as any single aspect or any combination of aspects described below or in connection with one or more other processes described elsewhere herein.

In a first aspect, the downlink BWP is contained within a first downlink subband of the plurality of downlink subbands.

In a second aspect, alone or in combination with the first aspect, the downlink BWP spans a first downlink subband of the plurality of downlink subbands and an uplink subband of the SBFD symbol, and the downlink message is received via one or more physical resource blocks within the first downlink subband.

In a third aspect, alone or in combination with one or more of the first and second aspects, process 800 includes transmitting, by the UE, an uplink message to the network node via an uplink BWP, wherein the uplink BWP spans the first downlink subband and the uplink subband, and wherein the uplink message is transmitted via one or more additional physical resource blocks within the uplink subband.

In a fourth aspect, alone or in combination with one or more of the first through third aspects, the downlink BWP spans the plurality of downlink subbands, and the downlink message is received via one or more physical resource blocks within a first downlink subband of the plurality of downlink subbands.

In a fifth aspect, alone or in combination with one or more of the first through fourth aspects, the downlink message is received via the first downlink subband in accordance with at least one of the first downlink subband having a lowest frequency resource of a plurality of frequency resources corresponding to the plurality of downlink subbands, or the first downlink subband being configured for transmission of common downlink signaling.

In a sixth aspect, alone or in combination with one or more of the first through fifth aspects, the message is transmitted when the UE is operating in an RRC idle mode or an RRC inactive mode.

In a seventh aspect, alone or in combination with one or more of the first through sixth aspects, the message comprises a preamble message transmitted via one or more ROs configured within one or more SBFD symbols, and the one or more ROs are dedicated for indicating the capability.

In an eighth aspect, alone or in combination with one or more of the first through seventh aspects, the message comprises a preamble message transmitted via one or more ROs configured within one or more SBFD symbols, wherein the preamble message includes a preamble selected from a plurality of preambles dedicated for indicating the capability.

In a ninth aspect, alone or in combination with one or more of the first through eighth aspects, process 800 includes transmitting, by the UE, an indication of one or more switching durations associated with at least one of switching from reception via a non-SBFD downlink symbols to reception via a single downlink subband of an SBFD symbol, or switching from reception via the single downlink subband of the SBFD symbol to reception via the non-SBFD downlink symbol.

In a tenth aspect, alone or in combination with one or more of the first through ninth aspects, the indication of the one or more switching durations comprises an indication of at least one of a quantity of symbols, a quantity of slots per numerology, or a time duration in microseconds or milliseconds.

In an eleventh aspect, alone or in combination with one or more of the first through tenth aspects, the one or more switching durations are selected from a plurality of configured switching durations.

In a twelfth aspect, alone or in combination with one or more of the first through eleventh aspects, process 800 includes transmitting, by the UE, an indication of one or more switching durations associated with at least one of switching from transmission via a non-SBFD uplink symbols to transmission via a single uplink subband of an SBFD symbol, or switching from transmission via the single uplink subband of the SBFD symbol to transmission via the non-SBFD uplink symbol.

In a thirteenth aspect, alone or in combination with one or more of the first through twelfth aspects, process 800 includes receiving, by the UE, a configuration of an RRC parameter for indicating one or more switching durations associated with at least one of switching from reception via a non-SBFD downlink symbol to reception via a single downlink subband of an SBFD symbol, or switching from reception via the single downlink subband of the SBFD symbol to reception via the non-SBFD downlink symbol.

In a fourteenth aspect, alone or in combination with one or more of the first through thirteenth aspects, process 800 includes receiving, by the UE, common signaling via one or more usable physical resource blocks in a first downlink subband of the plurality of downlink subbands in accordance with the capability.

In a fifteenth aspect, alone or in combination with one or more of the first through fourteenth aspects, process 800 includes switching, by the UE, from reception via the downlink BWP to a reception via an additional downlink BWP configured for the SBFD symbol, and receiving, by the UE, common signaling via the additional BWP.

In a sixteenth aspect, alone or in combination with one or more of the first through fifteenth aspects, process 800 includes switching, by the UE, from reception via a first downlink subband of the plurality of downlink subbands to reception via a second downlink subband of the plurality of downlink subbands, and receiving, by the UE, common signaling via the second downlink subband.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node (e.g., network node 110) or an apparatus of a network node. Example process 900 is an example where the apparatus or the network node performs operations associated with a single downlink subband capability indication for SBFD.

As shown in FIG. 9, in some aspects, process 900 may include receiving a message indicating a capability of a UE associated with reception of downlink communications via only one downlink subband per SBFD symbol (block 910). For example, the network node (e.g., using reception component 1102 or communication manager 1106, depicted in FIG. 11) may receive a message indicating a capability of a UE associated with reception of downlink communications via only one downlink subband per SBFD symbol, as described above.

As further shown in FIG. 9, in some aspects, process 900 may include transmitting a downlink message to the UE and via a downlink BWP comprising a plurality of downlink subbands in accordance with the message (block 920). For example, the network node (e.g., using transmission component 1104 or communication manager 1106, depicted in FIG. 11) may transmit a downlink message to the UE and via a downlink BWP comprising a plurality of downlink subbands in accordance with the message, as described above.

Process 900 may include additional aspects, such as any single aspect or any combination of aspects described below or in connection with one or more other processes described elsewhere herein.

In a first aspect, the downlink BWP is contained within a first downlink subband of the plurality of downlink subbands.

In a second aspect, alone or in combination with the first aspect, the downlink BWP spans a first downlink subband of the plurality of downlink subbands and an uplink subband of the SBFD symbol, and the downlink message is transmitted via one or more physical resource blocks within the first downlink subband.

In a third aspect, alone or in combination with one or more of the first and second aspects, process 900 includes receiving, by the network node, an uplink message from the UE via an uplink BWP, wherein the uplink BWP spans the first downlink subband and the uplink subband, and wherein the uplink message is received via one or more additional physical resource blocks within the uplink subband.

In a fourth aspect, alone or in combination with one or more of the first through third aspects, the downlink BWP spans the plurality of downlink subbands, and the downlink message is transmitted via one or more physical resource blocks within a first downlink subband of the plurality of downlink subbands.

In a fifth aspect, alone or in combination with one or more of the first through fourth aspects, the downlink message is transmitted via the first downlink subband in accordance with at least one of the first downlink subband having a lowest frequency resource of a plurality of frequency resources corresponding to the plurality of downlink subbands, or the first downlink subband being configured for transmission of common downlink signaling.

In a sixth aspect, alone or in combination with one or more of the first through fifth aspects, the message is received when the UE is operating in an RRC idle mode or an RRC inactive mode.

In a seventh aspect, alone or in combination with one or more of the first through sixth aspects, the message comprises a preamble message transmitted via one or more ROs configured within one or more SBFD symbols, and the one or more ROs are dedicated for indicating the capability.

In an eighth aspect, alone or in combination with one or more of the first through seventh aspects, the message comprises a preamble message transmitted via one or more ROs configured within one or more SBFD symbols, wherein the preamble message includes a preamble selected from a plurality of preambles dedicated for indicating the capability.

In a ninth aspect, alone or in combination with one or more of the first through eighth aspects, process 900 includes receiving, by the network node, an indication of one or more switching durations associated with at least one of the UE switching from reception via a non-SBFD downlink symbol to reception via a single downlink subband of an SBFD symbol, or the UE switching from reception via the single downlink subband of the SBFD symbol to reception via the non-SBFD downlink symbol.

In a tenth aspect, alone or in combination with one or more of the first through ninth aspects, the indication of the one or more switching durations comprises an indication of at least one of a quantity of symbols, a quantity of slots per numerology, or a time duration in microseconds or milliseconds.

In an eleventh aspect, alone or in combination with one or more of the first through tenth aspects, the one or more switching durations are selected from a plurality of configured switching durations.

In a twelfth aspect, alone or in combination with one or more of the first through eleventh aspects, process 900 includes transmitting, by the UE, an indication of one or more switching durations associated with at least one of switching from transmission via a non-SBFD uplink symbols to transmission via a single uplink subband of an SBFD symbol, or switching from transmission via the single uplink subband of the SBFD symbol to transmission via the non-SBFD uplink symbol.

In a thirteenth aspect, alone or in combination with one or more of the first through twelfth aspects, process 900 includes transmitting, by the network node, a configuration of an RRC parameter for indicating one or more switching durations associated with at least one of switching from reception via a non-SBFD downlink slot to reception via a single downlink subband of an SBFD slot, or switching from reception via the single downlink subband of the SBFD slot to reception via the non-SBFD downlink slot.

In a fourteenth aspect, alone or in combination with one or more of the first through thirteenth aspects, process 900 includes transmitting, by the network node, common signaling via one or more physical resource blocks, usable by the UE, in a first downlink subband of the plurality of downlink subbands in accordance with the capability.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE (e.g., UE 120), or a UE may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 2-7. Additionally, or alternatively, the apparatus 1000 may be configured to perform one or more processes described herein, such as process 800 of FIG. 8. In some aspects, the apparatus 1000 or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The transmission component 1004 may transmit a message indicating a capability associated with reception of downlink communications via only one downlink subband per SBFD symbol. The reception component 1002 may receive a downlink message from a network node and via a downlink BWP within an SBFD symbol comprising a plurality of downlink subbands in accordance with the capability.

The transmission component 1004 may transmit an uplink message to the network node via an uplink BWP, wherein the uplink BWP spans the first downlink subband and the uplink subband, and wherein the uplink message is transmitted via one or more additional physical resource blocks within the uplink subband.

The transmission component 1004 may transmit an indication of one or more switching durations associated with at least one of switching from reception via a non-SBFD downlink symbols to reception via a single downlink subband of an SBFD symbol, or switching from reception via the single downlink subband of the SBFD symbol to reception via the non-SBFD downlink symbol.

The transmission component 1004 may transmit an indication of one or more switching durations associated with at least one of switching from transmission via a non-SBFD uplink symbols to transmission via a single uplink subband of an SBFD symbol, or switching from transmission via the single uplink subband of the SBFD symbol to transmission via the non-SBFD uplink symbol.

The reception component 1002 may receive a configuration of an RRC parameter for indicating one or more switching durations associated with at least one of switching from reception via a non-SBFD downlink symbol to reception via a single downlink subband of an SBFD symbol, or switching from reception via the single downlink subband of the SBFD symbol to reception via the non-SBFD downlink symbol.

The reception component 1002 may receive common signaling via one or more usable physical resource blocks in a first downlink subband of the plurality of downlink subbands in accordance with the capability.

The communication manager 1006 may switch from reception via the downlink BWP to a reception via an additional downlink BWP configured for the SBFD symbol.

The reception component 1002 may receive common signaling via the additional downlink BWP.

The communication manager 1006 may switch from reception via a first downlink subband of the plurality of downlink subbands to reception via a second downlink subband of the plurality of downlink subbands.

The reception component 1002 may receive common signaling via the second downlink subband.

The number and arrangement of components shown in FIG. 10 are provided as an example. In practice, there may be additional components, fewer components, different components, or differently arranged components than those shown in FIG. 10.

Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node (e.g., network node 110), or a network node may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the network node.

In some aspects, the apparatus 1100 may be configured to perform one or more operations described herein in connection with FIGS. 2-7. Additionally, or alternatively, the apparatus 1100 may be configured to perform one or more processes described herein, such as process 900 of FIG. 9. In some aspects, the apparatus 1100 or one or more components shown in FIG. 11 may include one or more components of the network node described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network node described above in connection with FIG. 1, such as a radio, one or more RF chains, one or more transceivers, or one or more modems, each of which may in turn be coupled with one or more antennas of the network node. In some aspects, the reception component 1102 or the transmission component 1104 may include or may be included in a network interface. The network interface may be configured to obtain or output signals for the apparatus 1100 via one or more communications links, such as a backhaul link, a midhaul link, or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 may receive a message indicating a capability of a UE associated with reception of downlink communications via only one downlink subband per SBFD symbol. The transmission component 1104 may transmit a downlink message to the UE and via a downlink BWP comprising a plurality of downlink subbands in accordance with the message.

The reception component 1102 may receive an uplink message from the UE via an uplink BWP, wherein the uplink BWP spans the first downlink subband and the uplink subband, and wherein the uplink message is received via one or more additional physical resource blocks within the uplink subband.

The reception component 1102 may receive an indication of one or more switching durations associated with at least one of the UE switching from reception via a non-SBFD downlink symbol to reception via a single downlink subband of an SBFD symbol, or the UE switching from reception via the single downlink subband of the SBFD symbol to reception via the non-SBFD downlink symbol.

The transmission component 1104 may transmit an indication of one or more switching durations associated with at least one of switching from transmission via a non-SBFD uplink symbol to transmission via a single uplink subband of an SBFD symbol, or switching from transmission via the single uplink subband of the SBFD symbol to transmission via the non-SBFD uplink symbol.

The transmission component 1104 may transmit a configuration of an RRC parameter for indicating one or more switching durations associated with at least one of switching from reception via a non-SBFD downlink slot to reception via a single downlink subband of an SBFD slot, or switching from reception via the single downlink subband of the SBFD slot to reception via the non-SBFD downlink slot.

The transmission component 1104 may transmit common signaling via one or more physical resource blocks, usable by the UE, in a first downlink subband of the plurality of downlink subbands in accordance with the capability.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication by a UE, comprising: transmitting, by a UE, a message indicating a capability associated with reception of downlink communications via only one downlink subband per SBFD symbol; and receiving, by the UE, a downlink message from a network node and via a downlink BWP within an SBFD symbol comprising a plurality of downlink subbands in accordance with the capability.

Aspect 2: The method of Aspect 1, wherein the downlink BWP is contained within a first downlink subband of the plurality of downlink subbands.

Aspect 3: The method of any of Aspects 1-2, wherein the downlink BWP spans a first downlink subband of the plurality of downlink subbands and an uplink subband of the SBFD symbol, and wherein the downlink message is received via one or more physical resource blocks within the first downlink subband.

Aspect 4: The method of Aspect 3, further comprising: transmitting, by the UE, an uplink message to the network node via an uplink BWP, wherein the uplink BWP spans the first downlink subband and the uplink subband, and wherein the uplink message is transmitted via one or more additional physical resource blocks within the uplink subband.

Aspect 5: The method of any of Aspects 1-4, wherein the downlink BWP spans the plurality of downlink subbands, and wherein the downlink message is received via one or more physical resource blocks within a first downlink subband of the plurality of downlink subbands.

Aspect 6: The method of Aspect 5, wherein the downlink message is received via the first downlink subband in accordance with at least one of the first downlink subband having a lowest frequency resource of a plurality of frequency resources corresponding to the plurality of downlink subbands, or the first downlink subband being configured for transmission of common downlink signaling.

Aspect 7: The method of any of Aspects 1-6, wherein the message is transmitted when the UE is operating in a radio resource control (RRC) idle mode or an RRC inactive mode.

Aspect 8: The method of Aspect 7, wherein the message comprises a preamble message transmitted via one or more random access occasions (ROs) configured within one or more SBFD symbols, and wherein the one or more ROs are dedicated for indicating the capability.

Aspect 9: The method of Aspect 7, wherein the message comprises a preamble message transmitted via one or more random access occasions (ROs) configured within one or more SBFD symbols, wherein the preamble message includes a preamble selected from a plurality of preambles dedicated for indicating the capability.

Aspect 10: The method of any of Aspects 1-9, further comprising: transmitting, by the UE, an indication of one or more switching durations associated with at least one of switching from reception via a non-SBFD downlink symbols to reception via a single downlink subband of an SBFD symbol, or switching from reception via the single downlink subband of the SBFD symbol to reception via the non-SBFD downlink symbol.

Aspect 11: The method of Aspect 10, wherein the indication of the one or more switching durations comprises an indication of at least one of a quantity of symbols, a quantity of slots per numerology, or a time duration in microseconds or milliseconds.

Aspect 12: The method of any of Aspects 10-11, wherein the one or more switching durations are selected from a plurality of configured switching durations.

Aspect 13: The method of any of Aspects 1-12, further comprising: transmitting, by the UE, an indication of one or more switching durations associated with at least one of switching from transmission via a non-SBFD uplink symbols to transmission via a single uplink subband of an SBFD symbol, or switching from transmission via the single uplink subband of the SBFD symbol to transmission via the non-SBFD uplink symbol.

Aspect 14: The method of any of Aspects 1-13, further comprising: receiving, by the UE, a configuration of a radio resource control (RRC) parameter for indicating one or more switching durations associated with at least one of switching from reception via a non-SBFD downlink symbol to reception via a single downlink subband of an SBFD symbol, or switching from reception via the single downlink subband of the SBFD symbol to reception via the non-SBFD downlink symbol.

Aspect 15: The method of any of Aspects 1-14, further comprising: receiving, by the UE, common signaling via one or more usable physical resource blocks in a first downlink subband of the plurality of downlink subbands in accordance with the capability.

Aspect 16: The method of any of Aspects 1-15, further comprising: switching, by the UE, from reception via the downlink BWP to a reception via an additional downlink BWP configured for the SBFD symbol; and receiving, by the UE, common signaling via the additional downlink BWP.

Aspect 17: The method of any of Aspects 1-16, further comprising: switching, by the UE, from reception via a first downlink subband of the plurality of downlink subbands to reception via a second downlink subband of the plurality of downlink subbands; and receiving, by the UE, common signaling via the second downlink subband.

Aspect 18: A method of wireless communication performed by a network node, comprising: receiving, by a network node, a message indicating a capability of a UE associated with reception of downlink communications via only one downlink subband per SBFD symbol; and transmitting, by the network node, a downlink message to the UE and via a downlink BWP comprising a plurality of downlink subbands in accordance with the message.

Aspect 19: The method of Aspect 18, wherein the downlink BWP is contained within a first downlink subband of the plurality of downlink subbands.

Aspect 20: The method of any of Aspects 18-19, wherein the downlink BWP spans a first downlink subband of the plurality of downlink subbands and an uplink subband of the SBFD symbol, and wherein the downlink message is transmitted via one or more physical resource blocks within the first downlink subband.

Aspect 21: The method of Aspect 20, further comprising: receiving, by the network node, an uplink message from the UE via an uplink BWP, wherein the uplink BWP spans the first downlink subband and the uplink subband, and wherein the uplink message is received via one or more additional physical resource blocks within the uplink subband.

Aspect 22: The method of any of Aspects 18-21, wherein the downlink BWP spans the plurality of downlink subbands, and wherein the downlink message is transmitted via one or more physical resource blocks within a first downlink subband of the plurality of downlink subbands.

Aspect 23: The method of Aspect 22, wherein the downlink message is transmitted via the first downlink subband in accordance with at least one of the first downlink subband having a lowest frequency resource of a plurality of frequency resources corresponding to the plurality of downlink subbands, or the first downlink subband being configured for transmission of common downlink signaling.

Aspect 24: The method of any of Aspects 18-23, wherein the message is received when the UE is operating in a radio resource control (RRC) idle mode or an RRC inactive mode.

Aspect 25: The method of Aspect 24, wherein the message comprises a preamble message transmitted via one or more random access occasions (ROs) configured within one or more SBFD symbols, and wherein the one or more ROs are dedicated for indicating the capability.

Aspect 26: The method of Aspect 24, wherein the message comprises a preamble message transmitted via one or more random access occasions (ROs) configured within one or more SBFD symbols, wherein the preamble message includes a preamble selected from a plurality of preambles dedicated for indicating the capability.

Aspect 27: The method of any of Aspects 18-26, further comprising: receiving, by the network node, an indication of one or more switching durations associated with at least one of the UE switching from reception via a non-SBFD downlink symbol to reception via a single downlink subband of an SBFD symbol, or the UE switching from reception via the single downlink subband of the SBFD symbol to reception via the non-SBFD downlink symbol.

Aspect 28: The method of Aspect 27, wherein the indication of the one or more switching durations comprises an indication of at least one of a quantity of symbols, a quantity of slots per numerology, or a time duration in microseconds or milliseconds.

Aspect 29: The method of any of Aspects 27-28, wherein the one or more switching durations are selected from a plurality of configured switching durations.

Aspect 30: The method of any of Aspects 18-29, further comprising: transmitting, by the UE, an indication of one or more switching durations associated with at least one of switching from transmission via a non-SBFD uplink symbols to transmission via a single uplink subband of an SBFD symbol, or switching from transmission via the single uplink subband of the SBFD symbol to transmission via the non-SBFD uplink symbol.

Aspect 31: The method of any of Aspects 18-30, further comprising: transmitting, by the network node, a configuration of a radio resource control (RRC) parameter for indicating one or more switching durations associated with at least one of switching from reception via a non-SBFD downlink slot to reception via a single downlink subband of an SBFD slot, or switching from reception via the single downlink subband of the SBFD slot to reception via the non-SBFD downlink slot.

Aspect 32: The method of any of Aspects 18-31, further comprising: transmitting, by the network node, common signaling via one or more physical resource blocks, usable by the UE, in a first downlink subband of the plurality of downlink subbands in accordance with the capability.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

Aspect 40: A device comprising a processing system that includes one or more processors and one or more code-storing memories coupled with the one or more processors, the processing system configured to cause the device to perform the method of one or more of Aspects 1-32.

Aspect 41: A device comprising a processing system that includes processor circuitry and code-storing memory circuitry, the processing system configured to cause the device to perform the method of one or more of Aspects 1-32.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
transmit a message indicating a capability associated with reception of downlink communications via only one downlink subband per subband full duplex (SBFD) symbol; and
receive a downlink message from a network node and via a downlink bandwidth part (BWP) within an SBFD symbol comprising a plurality of downlink subbands in accordance with the capability.

2. The UE of claim 1, wherein the downlink BWP is contained within a first downlink subband of the plurality of downlink subbands.

3. The UE of claim 1, wherein the downlink BWP spans a first downlink subband of the plurality of downlink subbands and an uplink subband of the SBFD symbol, and wherein the downlink message is received via one or more physical resource blocks within the first downlink subband.

4. The UE of claim 3, wherein the one or more processors are further configured to cause the UE to:
transmit an uplink message to the network node via an uplink BWP, wherein the uplink BWP spans the first downlink subband and the uplink subband, and wherein the uplink message is transmitted via one or more additional physical resource blocks within the uplink subband.

5. The UE of claim 1, wherein the downlink BWP spans the plurality of downlink subbands, and wherein the downlink message is received via one or more physical resource blocks within a first downlink subband of the plurality of downlink subbands.

6. The UE of claim 5, wherein the downlink message is received via the first downlink subband in accordance with at least one of the first downlink subband having a lowest frequency resource of a plurality of frequency resources corresponding to the plurality of downlink subbands, or the first downlink subband being configured for transmission of common downlink signaling.

7. The UE of claim 1, wherein the message is transmitted when the UE is operating in a radio resource control (RRC) idle mode or an RRC inactive mode.

8. The UE of claim 7, wherein the message comprises a preamble message transmitted via one or more random access occasions (ROs) configured within one or more SBFD symbols, and wherein the one or more ROs are dedicated for indicating the capability.

9. The UE of claim 7, wherein the message comprises a preamble message transmitted via one or more random access occasions (ROs) configured within one or more SBFD symbols, wherein the preamble message includes a preamble selected from a plurality of preambles dedicated for indicating the capability.

10. The UE of claim 1, wherein the one or more processors are further configured to cause the UE to:
transmit an indication of one or more switching durations associated with at least one of switching from reception via a non-SBFD downlink symbols to reception via a single downlink subband of an SBFD symbol, or switching from reception via the single downlink subband of the SBFD symbol to reception via the non-SBFD downlink symbol.

11. The UE of claim 10, wherein the indication of the one or more switching durations comprises an indication of at least one of a quantity of symbols, a quantity of slots per numerology, or a time duration in microseconds or milliseconds.

12. The UE of claim 10, wherein the one or more switching durations are selected from a plurality of configured switching durations.

13. The UE of claim 1, wherein the one or more processors are further configured to cause the UE to:
transmit an indication of one or more switching durations associated with at least one of switching from transmission via a non-SBFD uplink symbols to transmission via a single uplink subband of an SBFD symbol, or switching from transmission via the single uplink subband of the SBFD symbol to transmission via the non-SBFD uplink symbol.

14. The UE of claim 1, wherein the one or more processors are further configured to cause the UE to:
receive a configuration of a radio resource control (RRC) parameter for indicating one or more switching durations associated with at least one of switching from reception via a non-SBFD downlink symbol to reception via a single downlink subband of an SBFD symbol, or switching from reception via the single downlink subband of the SBFD symbol to reception via the non-SBFD downlink symbol.

15. The UE of claim 1, wherein the one or more processors are further configured to cause the UE to:
receive common signaling via one or more usable physical resource blocks in a first downlink subband of the plurality of downlink subbands in accordance with the capability.

16. The UE of claim 1, wherein the one or more processors are further configured to cause the UE to:
switch from reception via the downlink BWP to a reception via an additional downlink BWP configured for the SBFD symbol; and
receive common signaling via the additional downlink BWP.

17. The UE of claim 1, wherein the one or more processors are further configured to cause the UE to:
switch from reception via a first downlink subband of the plurality of downlink subbands to reception via a second downlink subband of the plurality of downlink subbands; and
receive common signaling via the second downlink subband.

18. A method of wireless communication, comprising:
transmitting, by a user equipment (UE), a message indicating a capability associated with reception of downlink communications via only one downlink subband per subband full duplex (SBFD) symbol; and
receiving, by the UE, a downlink message from a network node and via a downlink bandwidth part (BWP) within an SBFD symbol comprising a plurality of downlink subbands in accordance with the capability.

19. The method of claim 18, wherein the downlink BWP is contained within a first downlink subband of the plurality of downlink subbands.

20. A network node for wireless communication, comprising:
one or more memories; and
one or more processors, coupled to the one or more memories, configured to cause the network node to:
receive a message indicating a capability of a user equipment (UE) associated with reception of downlink communications via only one downlink subband per subband full duplex (SBFD) symbol; and
transmit a downlink message to the UE and via a first downlink bandwidth part (BWP) comprising a plurality of downlink subbands in accordance with the message.
